(19) United States
(12) Patent Application Publication
(10) Pub. No.: US 2005/0082776 A1
(43) Pub. Date: Apr. 21, 2005

(54) Wheel mount assembly for a towable baggage

(76) Inventors: Mark Nordstrom, Brentwood, TN (US); Gary Ritter, St. Louis, MO (US)

Correspondence Address: Dean D. Small;Armstrong Teasdale LLP., Suite 2600, One Metropolitan Square, St. Louis, MO, 63102, US

(21) Appl. No.: 10/898,863

(22) Filed: Jul. 26, 2004

Related U.S. Application Data
(63) Continuation-in-part of application No. 29/173,626, filed on Jan. 2, 2003, now Pat. No. D498053.

(51) Int. Cl. B62B 1/00

(52) U.S. Cl. 280/37

(57) ABSTRACT

A wheeled baggage assembly provides a convenient mechanism for removably mounting and removing a wheel from a wheeled baggage. The wheeled baggage assembly includes a wheel mounting bracket designed to removably connect to a piece of baggage and to provide support for a wheel on which the baggage may roll. The preferred wheel mounting bracket of the wheeled baggage assembly has at least two locations for reversible connection to the baggage and provides support for a wheel only on one side of the wheel. The other side of the wheel is supported by another component of the wheeled baggage assembly.

### BACKGROUND OF THE INVENTION

1. Field of Invention

The invention generally relates to systems and methods for mounting wheels to towable baggage. More particularly, the invention relates to a wheeled baggage assembly that comprises a wheel mounting bracket element removably connected to the other elements of the wheeled baggage assembly and which, when mounted to the towable baggage, supports a wheel of the towable baggage on only one side of the wheel, the wheel being supported on the other side by another portion of the wheeled baggage assembly.

2. Description of Related Art

Providing wheels on articles of baggage for purposes of allowing the baggage to be towed in addition to being carried is well known in the art of baggage. As a result, many types of baggage are manufactured and sold with wheels attached to one or more sides of such baggage.

Traditional methods for securing wheels on baggage include both those wherein a wheel of the baggage is supported on two sides of the wheel, and those wherein the wheel is cantilevered, i.e., the wheel is supported only on one side, generally by support of the wheel axle on one side of the wheel. An advantage of the cantilever mount is that the wheel need not be enclosed in any way, making both assembly and removal for repair or replacement easy. Another advantage of the cantilever mount is that the wheel can be positioned outside the edge of the piece of baggage through simple engineering, a placement that may provide additional stability due to a wider wheelbase on which the baggage is supported during rolling. A significant disadvantage of the cantilevered wheel mount, however, is its relative weakness with respect to a torque on the wheel about the point of connection of the wheel to the baggage. Without the additional support provided when a wheel is mounted on two sides, the wheel and its connection to the baggage is significantly more susceptible to damage when the wheel is impacted, such as by a curb or other bump in the rolling surface.

Generally, the wheels of the wheeled baggage provide support for a majority of the weight of the baggage and its contents while the piece of baggage is being towed, so every bump and dip along the rolling surface is an impact to the wheel that may cause damage to the wheel or its connection to the baggage. Additionally, the wheels of towable baggage, regardless of how they are mounted, protrude from at least one edge of the baggage in order to support the baggage when rolling, so that even when not being used for rolling, the wheels are susceptible to impacts causing torques on the wheel connection and potentially damage thereto. these potential sources of damage to the wheels and their connection to the baggage are particularly problematic for cantilever mounted wheels.

Rather than the generally weaker cantilevered construction, generally stronger support for the wheels of towable baggage has traditionally been provided through support on two sides of the wheel. Such support is usually provided by a single support element to which the wheel is attached on two sides, the single support element wrapping around the wheel from one side to the other, partially enclosing the wheel along a portion of the wheel's circumference. An example of such a single support element is provided by a traditional caster mount. A caster mount generally supports the wheel in a two-pronged fork that extends from a single rod. The single rod is used to mount the wheel and fork in a manner that allows pivoting movement of the fork and the wheel around an axis passing through the rod, an axis that is generally perpendicular to the axis of rotation of the wheel, and generally perpendicular to the surface on which the wheel is rolling. Because there is only a single rod used to mount the fork and wheel, casters have their own weaknesses similar to those of cantilever mounted wheels. While the caster mount supports the wheel on two sides, the caster mount is only connected to the assembly on which the wheel is mounted through the single fork-supporting rod that generally extends from the side of the wheel opposite the rolling surface. That single connection between the caster and the wheeled assembly is prone to damage by torques tending to rotate the wheel about that single connection around axes not coincident with the single rod, just as are cantilever supported wheels.

Other than the caster mount, two-sided support for a wheel on towable baggage is usually provided by a single molded plastic element forming an enclosing wheel well into which the wheel is placed for mounting. The wheel well is usually either part of the base of the baggage or an external attachment to the baggage. These wheel well elements often are not designed to withstand the stresses provided by the jolts to the wheels when a fully loaded piece of baggage is being towed. The weakness of even the two-sided support is particularly observed where the wheel well is a portion of the base of the baggage, since in some pieces of baggage, the molded plastic base elements are designed primarily to give form to an otherwise soft-sided piece of baggage, and are not designed particularly for providing a rugged wheel support. So, even while there is conceivably added strength from the two sided support, such added strength is not a practical benefit in some designs.

Besides certain weak designs as just described, another disadvantage of the one-piece enclosed wheel well configuration is the limited access provided to the wheel. Where a single support unit surrounds the wheel on two sides, the assembling of the wheel into the single support unit is not nearly as simple as for the cantilevered mount. Likewise, where a wheel supported by such a single surrounding support is damaged, or for some other reason it is desirable to remove the wheel, the limited access provided to the wheel by the single surrounding support makes the task of removal and repair or replacement difficult.

### SUMMARY OF THE INVENTION

Embodiments of the invention herein disclosed provide for a wheeled baggage assembly that includes a rollable piece of baggage having at least one wheel supported on two sides, which wheel, at least in part, supports the wheeled baggage assembly as it is rolled along a rolling surface. Support for the wheel is provided by a wheel mount assembly comprising more than one wheel-supporting element. One of the wheel-support elements is a wheel mounting bracket. In an embodiment of the invention, a wheel of the baggage will be supported on one side by the shell of the baggage or an element connected thereto, such as a base portion of the baggage or a housing connected thereto, and on the other side by a wheel mounting bracket that removably attaches to the wheeled baggage assembly at a minimum of two locations. The wheel mounting bracket is an independent element from other elements of the baggage and is designed to be removably attached to and removed from the baggage without damage to any element of the wheeled baggage assembly. In an embodiment the separate wheel mounting bracket is designed to be particularly supportive of the wheel, e.g., by being made of a particularly rigid and durable material or by being made in dimensions (such as thickness) that provide such support, or a combination of these designs, or by another design.

The wheeled baggage assembly design which provides for a wheel mounting bracket separate from, but connected to, a piece of baggage, generally provides for a simplified mounting of the wheel, especially compared with a piece of baggage for which a wheel is mounted in a wheel well that is molded into a single base element of the baggage and that encloses a large portion of the wheel. By using the separate wheel mounting bracket design, as in embodiments of the present invention, the wheel well (if present) and therefore the wheel, are not enclosed until the wheel mounting bracket is attached to the piece of baggage. A preferable design for a wheeled baggage assembly using a separate wheel mounting bracket essentially provides a wheel well that is formed as a recess in the exterior of the baggage and that is exposed (i.e., not enclosed) on the exterior side of the baggage. The wheel well of the preferred embodiment is multiply recessed so as to accommodate placement of a wheel within a first recess of the wheel well and the placement of a wheel mounting bracket within a second recess of less depth than the first recess such that the wheel mounting bracket encloses the wheel in the wheel well and is positioned generally flush with the exterior side of the wheel well. The wheel mounting bracket so placed supports the wheel on one side of a plane includes the circumference of the wheel that is in contact with the rolling surface during a complete revolution (herein termed the contact circumference) and as such divides the wheel into two sides. Where this wheel mount design is used to mount wheels on two opposite sides of a generally parallel piped piece of baggage, the design maintains the widest practical wheelbase for the baggage without the wheels or wheel mounting brackets protruding from the plane that generally contains the side of the baggage, thus providing the greatest possible stability to the rolling baggage while maintaining wheel support on two sides of the wheel.

In an embodiment, a wheeled baggage assembly comprises a piece of baggage, a wheel connected to the piece of baggage so as to allow the wheeled baggage assembly to be rolled on the wheel over a rolling surface, and a wheel mounting bracket for supporting the wheel. In this embodiment the wheel is supported from two opposing sides of a plane defined through a circumference of the wheel, which circumference contacts the rolling surface during rolling of the wheeled baggage assembly over the rolling surface. The wheel mounting bracket supports the wheel on one of the two sides of the plane, and is designed to removably connect to the wheeled baggage assembly in at least two locations. On the opposing side of the plane from the side on which the wheel is supported by the wheel mounting bracket, the wheel is supported by a portion of the wheeled baggage assembly other than the wheel mounting bracket.

In another embodiment, the wheel of the wheeled baggage assembly further comprises an axle aligned with an axis of rotation of the wheel. In an alternate embodiment, one of the at least two locations of connection of the wheel mounting bracket to the wheeled baggage assembly is a connection including this axle. In a further alternate embodiment the connection including the axle of the wheel provides for the axle passing through the wheel mounting bracket. In yet another embodiment, attachment of the wheel mounting bracket at each of the at least two locations securely mounts the wheel mounting bracket and the wheel to the piece of baggage.

In an embodiment, the wheel mounting bracket has a generally constant thickness. In an alternate embodiment the wheel mounting bracket is of a generally planar design. In another embodiment, the wheel mounting bracket presented in a side elevation view generally has the shape of an isosceles triangle. In a further embodiment, the wheeled baggage assembly is designed to allow the wheel mounting bracket to be mounted generally flush with the side of the piece of baggage. In a still further embodiment, the wheeled baggage assembly is designed to allow the wheel mounting bracket to be mounted at an acute angle relative to a generally planar exterior surface of the piece of baggage.

In another embodiment, the wheeled baggage assembly further comprises an outer housing. In an alternate embodiment, the outer housing has a recess in which the wheel mounting bracket is mounted. In a further alternate embodiment, the outer housing is a portion of one of a rigid base and a rigid shell of the piece of baggage. In a still further alternate embodiment, the wheeled baggage assembly further comprises an inner housing, also. In yet another embodiment, a portion of a shell of the piece of baggage is held tightly between the inner and outer housings when the wheeled baggage assembly is assembled.

An embodiment is a method of mounting a wheel on a piece of towable baggage, the method comprising: providing a wheeled baggage assembly including a piece of baggage, a wheel connected to the piece of baggage, and a wheel mounting bracket for supporting the wheel, all as described above; and mounting the wheel on the piece of baggage so that the wheel is supported by the wheel mounting bracket on one side of the plane defined through a circumference of the wheel, and by a portion of the wheeled baggage assembly other than the wheel mounting bracket on the other side of the plane.

In an embodiment, a wheeled baggage assembly comprises a piece of baggage; a rolling means for allowing the wheeled baggage assembly to be rolled over a rolling surface, the rolling means connected to the piece of baggage on two sides of a plane that includes the circumference of the rolling means that contacts the rolling surface during rolling of the wheeled baggage assembly; a supporting means for supporting the rolling means on only one side of the plane, the supporting means being designed for removable connection to the piece of baggage.

### BRIEF DESCRIPTION OF THE FIGURES

FIG. 1 provides a perspective view of an embodiment of a wheel mount assembly fully assembled.

FIG. 2 provides an exploded perspective view of the wheel mount assembly of FIG. 1.

FIG. 3 depicts a perspective view of another embodiment of a wheel mount assembly, particularly showing another embodiment of a wheel mounting bracket.

FIG. 4 depicts a perspective view of yet another embodiment of a wheel mount assembly, particularly showing a further embodiment of a wheel mounting bracket.

FIG. 5 provides an elevation view of an embodiment of a wheel mount assembly as viewed from the rolling surface.

### DETAILED DESCRIPTION OF THE PREFERRED EMBODIMENT(S)

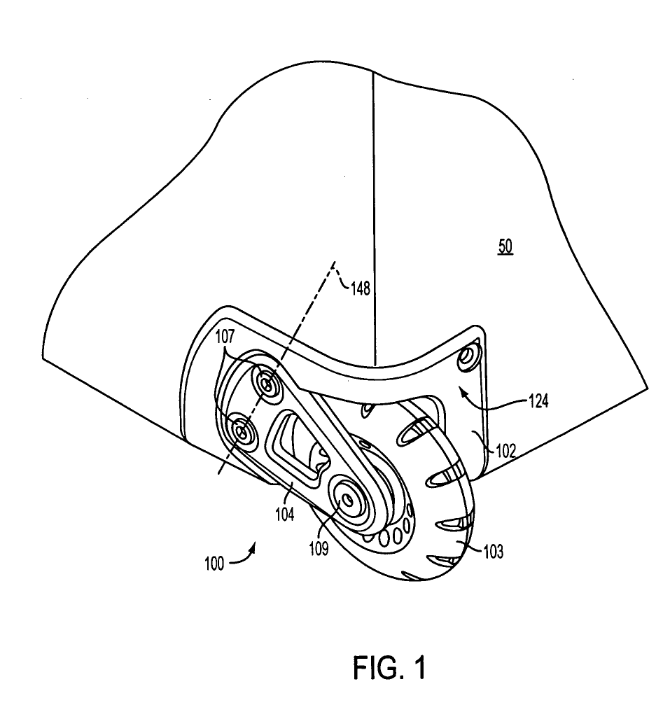

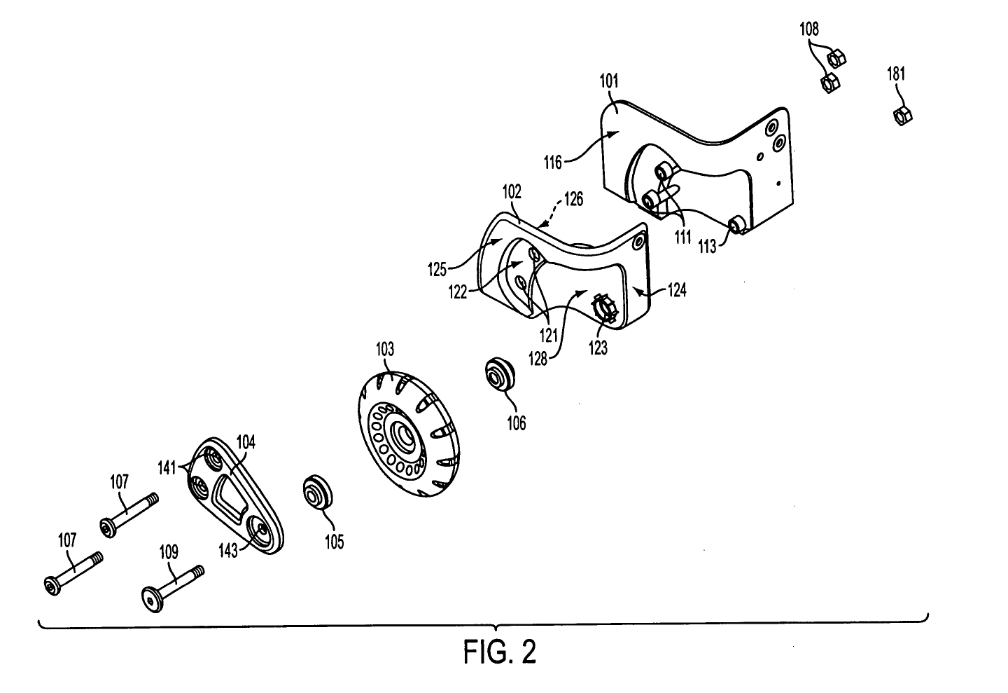

FIGS. 1 and 2 provide depictions of portions of an embodiment of a wheeled baggage assembly that includes an embodiment of a wheel mount assembly 100. The wheeled baggage assembly is not shown in its entirety as the elements that are not shown are well understood by those of ordinary skill in the art. The elements that are shown are the elements closely associated with the mounting of the wheel in this embodiment.

FIG. 1 shows, in part, an embodiment of an assembled wheel mount assembly 100, depicting the interrelationship of some of the components thereof when assembled. Visible in FIG. 1 (a perspective view from exterior to the wheeled baggage assembly) are two mounting bolts 107 toward the top of the wheel mounting bracket 104, which mounting bolts 107 attach the wheel mounting bracket 104 to the outer housing 102 and to the inner housing 101 (shown in FIG. 2), as well as operating to hold the outer housing 102 adjacent to the inner housing 101. At the opposite end of the wheel mounting bracket 104 from the mounting bolts 107 is the axle bolt 109, which passes through the wheel mounting bracket 104, the wheel 103, and the inner and outer housing 101 and 102, and operates as an axle and defines an axis about which the wheel 103 rotates. By tightly holding together all the components through which the axle bolt 109 passes (shown in FIG. 2), the axle bolt 109 acts in cooperation with the mounting bolts 107 to hold the wheel mount assembly 100 in an assembled configuration. In an embodiment the mounting bolts 107 and axle bolt 109 also act to secure the wheel mounting assembly 100 to the wheeled baggage assembly.

The exploded view of FIG. 2 shows more clearly how the two mounting bolts 107 act in conjunction with the axle bolt 109 to securely hold the components of the wheel mount assembly 100 together, rigidly and stably holding the wheel 103 in place relative thereto, and relative to the piece of baggage when such wheel mount assembly 100 is mounted to such baggage. From this figure it is perceptible that the inner and outer housing 101 and 102 are shaped to conform to one another, so that when the second side 126 of the outer housing 102 is placed adjacent to the first side 116 of the inner housing 101, these adjacent surfaces are generally touching or in close proximity to one another over a large portion of the adjacent surface areas.

The embodiment shown in FIGS. 1 and 2 is designed to be particularly useful for mounting on a soft-sided piece of baggage, which can be accomplished by placing the fabric or other material forming the “shell” 50 of the soft-sided baggage between the inner and outer housings 101 and 102. To assemble the wheel mount assembly 100 with the soft sided shell 50 between the inner and outer housing 101 and 102, the mounting bolts 107 and axle bolt 109 generally pass through the soft side 50 of the baggage. By so arranging the soft side 50 of the baggage between the inner and outer housing 101 and 102, after assembly of the wheel mount assembly 100, the soft side 50 of the baggage is held tightly in a constant position relative to the wheel mount assembly 100, at least in the immediate vicinity of the inner and outer housing 101 and 102.

In alternate embodiments, either or both of the inner and outer housing 101 and 102 may be portions of a larger, generally rigid base of the piece of baggage, which base may be utilized to support a soft-sided shell 50 or for other purposes. In further alternate embodiments, either or both of the inner and outer housing 101 and 102 may be absent from the wheel mount assembly 100. For example, where the shell 50 of the baggage is rigid (“hard-sided”), rather than of a soft-sided construction, portions of the wheel mount assembly, notably the wheel mounting bracket 104, may be attached directly to the rigid side of the baggage, rather than to either or both of the inner and outer housing 101 and 102. In other words, in an embodiment having neither of the inner and outer housing 101 and 102, the hard-sided shell 50 is molded to form the recesses into which the wheel 103 and the wheel mounting bracket 104 can be placed, and provides the holes 111 and 113 through which the mounting bolts 107 and axle bolt 109 pass in order to secure the wheel 103 and wheel mounting bracket 104 to the wheeled baggage assembly.

The embodiment depicted in FIG. 2 is assembled as follows. Observable on the outer housing 102 is a first recessed area 122 shaped to correspond to the shape of a portion of the wheel mounting bracket 104, and into which the wheel mounting bracket 104 can be placed so as to align certain holes 141 of the wheel mounting bracket 104 with certain holes 121 of the outer housing 102, which also align with certain holes 111 of the inner housing 101. When these components (wheel mounting bracket 104 and inner and outer housing 101 and 102) are so aligned, the third hole 143 in the wheel mounting bracket 104 is then aligned with the holes 123 and 113 in the outer and inner housing 102 and 101, respectively. Prior to so aligning the wheel mounting bracket 104 with the inner and outer housing 101 and 102, the wheel 103 and wheel bearings 105 and 106 must be aligned and placed in the second recessed area 128 such that the through holes in the wheel 103 and wheel bearings 105 and 106 align with the hole 123 in the outer housing 102. Once the wheel 103 and wheel bearings 105 and 106 are so aligned, the wheel mounting bracket 104 and inner housing 101 are brought into alignment as discussed above so that mounting bolts 107 can be passed through the holes 141, 121, and 111, and secured with nuts 108, and axle bolt 109 can be passed through hole 143, the holes through each of the wheel 103 and wheel bearings 105 and 106, and holes 123 and 113, and secured with nut 181. Each of these components (wheel mounting bracket 104, wheel 103, wheel bearings 105 and 106, and outer and inner housing 102 and 101) are thus secured together as shown in FIG. 1. Because of the functionality and configuration of the two wheel bearings 105 and 106, all of the components through which the axle bolt 109 passes can be snugly secured by the axle bolt 109 while still allowing the wheel 103 to rotate freely.

As just described, the mounting bolts 107 and the axle bolt 109 perform the function of holding the wheel mounting bracket 104 to the outer housing 102 and to the inner housing 101. While in this preferred embodiment the functions of the mounting bolts 107 and axle bolt 109 are performed by traditional bolts having a bolt head, shaft, and threads, and being secured with a nut, the functions of removably securing together the components of the wheel mount assembly 100 in a manner that allows the wheel to rotate about an axis can be performed by any number of mounting methods, such as by use of screws, snaps, ties, detents, and magnets. In a preferred embodiment the mechanism by which the wheel mounting bracket 104 is connected to the wheeled baggage assembly is designed to allow the wheel mounting bracket 104 to be removably attached and removed without damage to any of the elements of the wheeled baggage assembly. An example of such a design for reversible attachment and removal of the wheel mounting assembly 104 is provided by traditional bolts attached with nuts, in which case the nuts can be easily tightened for attaching the wheel mounting bracket 104 and, in reverse, loosened and removed for removal of the wheel mounting bracket 104.

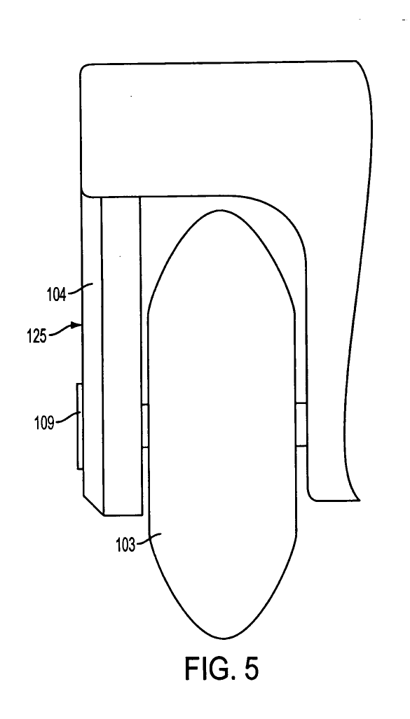

The recessed area 122 in the outer housing 102 allows the wheel mounting bracket 104 to be positioned generally flush with the first side 125 of the outer housing 102. If such outer housing 102 is mounted generally flush with the baggage, then so too is the wheel mounting bracket 104 generally flush with the side of the baggage. By configuring the wheel mount assembly 100 flush with a side of the baggage, the wheel mounting bracket 104 is protected from impacts it would otherwise sustain if the wheel mounting bracket 104 were positioned outside the plane generally coinciding with the side of the piece of baggage. While flush mounting of the wheel mounting bracket 104 is preferable, neither the recessed area 122 in the outer housing 102 nor flush mounting of the bracket by any other method are necessary. Additionally, the recessed area 122 may be of a depth such that the wheel mounting bracket 104 is mounted in a recessed position relative to the first side 125 of the outer housing 102 and, therefore, relative to the side of the baggage. Note that similar positioning of the axle bolt 109 relative to the first side 125 of the housing or the side of the baggage is possible. That is, although the axle bolt 109 is shown in FIG. 5 to protrude to a certain extent beyond the first side 125 of the outer housing 102, this axle bolt 109 could also be positioned flush or recessed as compared with the first side 125 of the outer housing 102 or the side of the baggage.

With respect to the recessed area 122 it can be seen in FIGS. 1 and 2 that the recessed area 122 is not squarely aligned with the edges of the outer housing 102. For example, where the rear surface 124 of the outer housing 102 generally defines a plane, the line 148 defined by the center of the holes 141 is not parallel to the plane of the rear surface 124. In this way, in an embodiment, the wheel mounting bracket 104 is mounted at an acute angle with respect to the rear surface 124 of the outer housing 102, which rear surface 124 is generally parallel to a generally planar, exterior surface of the piece of baggage. In an embodiment, this angled mounting of the wheeled mounting bracket 104 simply allows the center of the wheel 103 to be positioned near two edges of the baggage such that the wheel 103 protrudes from those two edges, enabling the wheel 103 to support the baggage in an elevated position with respect to the rolling surface. In another embodiment, such angled mounting of the wheel mounting bracket 104 with respect to the outer housing 102 may reduce the component of the force that tends to rotate the wheel mounting bracket 104 about either of the mounting bolts 107 when, during towing, the wheel 103 is impacted, such as by a bump in the rolling surface. In an embodiment, the acute angle of the wheel mounting bracket 104 with respect to one of the outer housing 102 and an exterior surface of the baggage allows for less stress and strain to be transmitted to the wheel mounting bracket 104 as the wheel 103 rolls over bumps or is otherwise impacted. Note that whereas for certain embodiments, such as the hard-sided baggage discussed above, the outer housing 102 is not a necessary element of the wheeled baggage assembly (and neither is the rear surface 124 necessary) the angle of mounting of the wheel mounting bracket 104 may be measured against a generally planar, exterior surface of the baggage, such as a generally horizontal bottom surface.

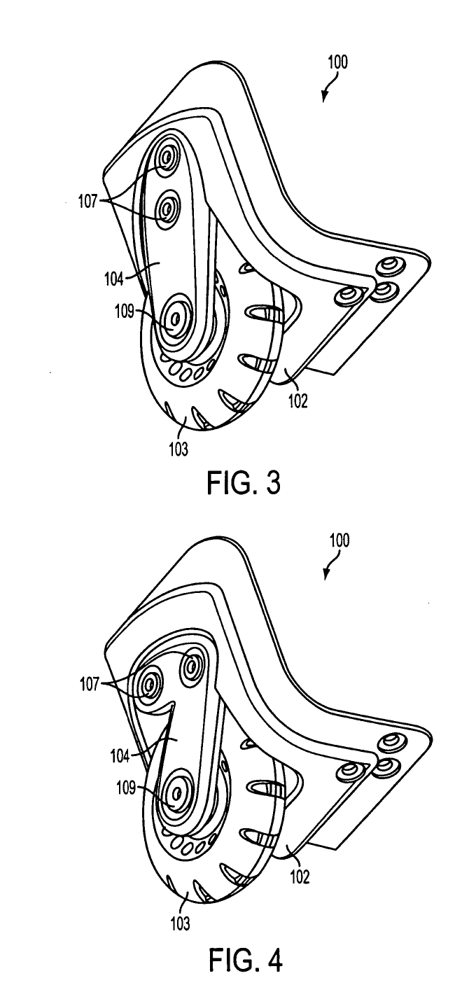

Discussion will now focus on the wheel mounting bracket 104. In the embodiment shown in FIGS. 1 and 2, the wheel mounting bracket 104 is generally shaped as an isosceles triangle when viewed in side elevation, such a triangle having rounded corners. This generally triangular shape provides some width across which the wheel mounting bracket 104 may be attached to the baggage, such as by the mounting bolts 107. Placing the mounting bolts 107 at a certain distance from one another along a direction predominantly aligned with a side of the wheel mounting bracket 104, as depicted for example in FIG. 1, provides more resistance to a torque about either mounting bolt 107 than if the mounting bolts 107 were closer together. The generally triangular shape of the wheel mounting bracket 104 is not necessary for sturdy mounting, though, and embodiments having alternate shapes are shown in FIGS. 3 and 4.

The designs of FIGS. 3 and 4, as well as other designs, may be more advantageous for some uses, e.g., on certain baggage. FIG. 3 shows a wheel mounting bracket 104 that is linear in nature, being generally long and narrow. Certain strength with respect to rotation about either of the mounting bolts 107 is provided by the displacement of these bolts along the length of the wheel mounting bracket 104, similar to the strength provided by the displacement of mounting bolts 107 in the triangular design of the embodiment of FIGS. 1 and 2. FIG. 4 shows a wheel mounting bracket 104 that comprises a single acute angle. It has an appearance somewhat similar to that of the number seven (“7”), and also provides locations for the displacement of the mounting bolts 107. Both of these embodiments can be designed to be mounted on the baggage at an acute angle with respect to a side of the baggage as discussed above with regard to the wheel mounting bracket 104 of FIGS. 1 and 2. As would be understood by one of ordinary skill in the art, other designs for the shape of the wheel mounting bracket 104 are essentially unlimited, so long as they are useful for removably mounting a wheel on baggage. The embodiments herein described and illustrated are merely exemplary of the useful designs for a wheel mounting bracket 104 that are encompassed by embodiments of the present invention.

Among the various designs for the wheel mounting bracket 104, there is a commonality in the way the wheel mounting bracket 104 is mounted to the wheeled baggage assembly. Embodiments of the wheel mounting bracket 104 are attached to the wheeled baggage assembly in at least two locations, one of which supports the wheel 103. Preferably, the wheel mounting bracket 104 is connected to the wheeled baggage assembly in at least two locations. As described above, the separation of the mounting locations, especially where there are at least three such mounting locations, can provide added stability to the wheel mounting assembly 100, in particular as against rotation about any of the mounting locations when the wheel 103 is impacted while rolling.

In the embodiment shown in FIGS. 1 and 2, the wheel mounting bracket 104 is of a generally constant thickness in the dimension generally defined by the direction in which the mounting bolts 107 pass through the wheel mounting bracket 104. The wheel mounting bracket 104, however, may be tapered toward or away from any edge or toward or away from any one or more points or lines in the interior volume of the wheel mounting bracket 104. Where the wheel mounting bracket 104 is of constant thickness, it can be considered to have a generally planar design when considering the plane generally perpendicular to the general direction in which the mounting bolts 107 pass through the wheel mounting bracket 104. Designs that are non-planar with respect to the same dimension may also be used, for example, wheel mounting brackets 104 that are curved or angled (such as an arcuate or cornered wheel mounting bracket 104). Advantages of such a non-planar shape include an ability to easily mount a wheel on a piece of baggage that has no recess or wheel well, by providing a wheel mounting bracket 104 that curves outward from the baggage around a wheel, and the ability, thereby, to increase the wheelbase (where more than one wheel is used) to a distance greater than the width of the baggage, perhaps improving rolling stability. An advantage of the constant-thickness, planar design is the inherent strength of the design compared with the curved or angled designs and the option of simple flush mounting of the wheel mounting bracket 104 (as discussed above) while maintaining the wheelbase at nearly the greatest possible width without having the wheels 103 or the wheel mounting bracket 104 protrude from the side of the baggage. While slight advantage in terms of weight, cost, or wheelbase may be obtained from thinner or tapered wheel mounting brackets 104, thinner materials usually lead to less rigidity and durability, which may be disfavored depending on the application for which the wheel mounting bracket 104 is to be used.

The material composition of the wheel mounting bracket 104 should be rigid so as to provide the necessary support for the wheeled baggage, and durable, minimally meaning impact resistant and not particularly brittle. The composition of the wheel mounting bracket 104 may be that of nearly any material, including homogeneous materials, such as steel, aluminum, other metal alloys that may include titanium, for example, and resins and plastics of various types; and non-homogeneous materials such as laminate materials and fibrous materials, including carbon fiber composites, fiberglass, and natural plant and animal based materials.

While the invention has been disclosed in connection with certain preferred embodiments, these particular embodiments and the descriptions thereof are not limitations on the present invention. Modifications and variations of the described embodiments may be made without departing from the spirit and scope of the invention, and other embodiments should be understood to be encompassed in the present disclosure as would be understood by one of ordinary skill in the art.

1. A wheeled baggage assembly comprising:
a piece of baggage;
a wheel connected to said piece of baggage so as to allow said wheeled baggage assembly to be rolled on said wheel over a rolling surface, said wheel supported from two opposing sides of a plane defined through a circumference of said wheel, said circumference contacting said rolling surface during rolling of said wheeled baggage assembly over said rolling surface; and
a wheel mounting bracket for supporting said wheel on one of said two sides of said plane, said wheel mounting bracket designed to removably connect to said wheeled baggage assembly in at least two locations;
wherein said wheel is supported by a portion of said wheeled baggage assembly other than said wheel mounting bracket on the opposing side of said plane.

2. The wheeled baggage assembly of claim 1, wherein said wheel further comprises an axle aligned with an axis of rotation of said wheel.

3. The wheeled baggage assembly of claim 2, wherein one of said at least two locations of connection of said wheel mounting bracket to said wheeled baggage assembly is a connection including said axle.

4. The wheeled baggage assembly of claim 3, wherein said connection including said axle of said wheel provides for the axle passing through said wheel mounting bracket.

5. The wheeled baggage assembly of claim 1, wherein said wheel mounting bracket has a generally constant thickness.

6. The wheeled baggage assembly of claim 5, wherein said wheel mounting bracket is of a generally planar design.

7. The wheeled baggage assembly of claim 1, wherein said wheel mounting bracket presented in a side elevation view generally has the shape of an isosceles triangle.

8. The wheeled baggage assembly of claim 1, said wheeled baggage assembly being designed to allow said wheel mounting bracket to be mounted generally flush with the side of said piece of baggage.

9. The wheeled baggage assembly of claim 1, wherein attachment of said wheel mounting bracket at each of said at least two locations securely mounts said wheel mounting bracket and said wheel to said piece of baggage.

10. The wheeled baggage assembly of claim 1, said wheeled baggage assembly being designed to allow said wheel mounting bracket to be mounted at an acute angle relative to a generally planar exterior surface of said piece of baggage.

11. The wheeled baggage assembly of claim 1, further comprising an outer housing.

12. The wheeled baggage assembly of claim 11, wherein said outer housing has a recess in which said wheel mounting bracket is mounted.

13. The wheeled baggage assembly of claim 11, wherein said outer housing is a portion of one of a rigid base and a rigid shell of said piece of baggage.

14. The wheeled baggage assembly of claim 11, further comprising an inner housing.

15. The wheeled baggage assembly of claim 14, wherein a portion of a shell of said piece of baggage is held tightly between said inner and outer housings when said wheeled baggage assembly is assembled.

16. A method of mounting a wheel on a piece of towable baggage, comprising: providing a wheeled baggage assembly comprising:
a piece of baggage;
a wheel connected to said piece of baggage so as to allow said wheeled baggage assembly to be rolled on said wheel over a rolling surface, said wheel supported on two sides of a plane that includes the circumference of said wheel that contacts said rolling surface during rolling of said wheeled baggage assembly over said rolling surface; and
a wheel mounting bracket for supporting said wheel on only one side of said plane, said wheel mounting bracket designed to removably connect to said wheeled baggage assembly in at least two locations; and mounting said wheel on said piece of baggage so that said wheel is supported by said wheel mounting bracket on one side of said plane, and by a portion of said wheeled baggage assembly other than said wheel mounting bracket on the other side of said plane.

17. A wheeled baggage assembly comprising:
a piece of baggage;
a rolling means for allowing said wheeled baggage assembly to be rolled over a rolling surface, said rolling means connected to said piece of baggage on two sides of a plane that includes the circumference of said rolling means that contacts said rolling surface during rolling of said wheeled baggage assembly;
a supporting means for supporting said rolling means on only one side of said plane, said supporting means being designed for removable connection to said piece of baggage.
